(19) United States
(12) Patent Application Publication
(10) Pub. No.: US 2014/0162096 A1
(43) Pub. Date: Jun. 12, 2014

(54) Battery Flow Frame Material Formulation

(71) Applicants: Lotte Chemical Corporation, Seoul (KR); ZBB Energy Corporation, Menomonee Falls, WI (US)

(72) Inventors: Peter Lex, Menomonee Falls, WI (US); Nathan Coad, Bateman (AU)

(73) Assignees: Lotte Chemical Corporation, Seoul (KR); ZBB Energy Corporation, Menomonee Falls, WI (US)

(21) Appl. No.: 14/182,487

(22) Filed: Feb. 18, 2014

Related U.S. Application Data
(63) Continuation-in-part of application No. 13/591,802, filed on Aug. 22, 2012.

(51) Int. Cl. H01M 2/38; B29B 9/06; B29C 45/00; C08L 23/12

(52) U.S. Cl. CPC H01M 2/38; C08L 23/12; B29B 9/06; B29C 45/0001
USPC 429/81; 525/240; 524/451; 524/449; 524/528; 264/141

(57) ABSTRACT

Disclosed herein are formulation components for the manufacturing of a flow frame structure that can be integrated in flowing electrolyte batteries. These formulation components for manufacturing flow frames may include, but are not limited to, polypropylene, glass fiber, a coupling agent and an elastomer. A mixing and extrusion process may be employed to formulate the material and produce pre-formulated pellets for the manufacturing of flow frames. As flow frames may be integrated with electrodes (or membranes), the disclosed flow frame formulation may achieve a desired Melt Flow Index (MFI) range and may allow an improved bonding between electrodes (or membranes) and flow frame, therefore, simplifying manufacturing process and achieving higher performance and longer lifetime of flowing electrolyte batteries.

### CROSS-REFERENCE TO RELATED APPLICATIONS

This application claims priority as a continuation-in-part of U.S. Non-Provisional patent application Ser. No. 13/591,802, filed on Aug. 22, 2012, which in turn claims priority from U.S. Provisional Patent Application Ser. No. 61/526,146, filed on Aug. 22, 2011, the entirety of which are each expressly incorporated by reference herein.

### BACKGROUND

1. Field

This invention relates generally to flowing electrolyte battery systems, and more particularly, to material formulations for flow frames employed in flowing electrolyte batteries.

2. Background Information

The performance of electrochemical storage devices involves complex, interrelated physical and chemical processes between electrode materials and electrolytes. Lead acid batteries are among the most used energy storage devices, but have several limitations in both performance, and environmental safety. Uninterruptable power systems have incorporated battery technology to allow smooth power feeding switch-over in the event of power failure.

Flowing electrolyte batteries offer a potential to overcome the above mentioned limitations of lead-acid batteries. In particular, the useful lifetime of flowing electrolyte batteries is not affected by deep discharge applications, and the energy to weight ratio of flowing electrolyte batteries is up to six times higher than that of lead-acid batteries. However, there is room for improvement in many aspects of the design, including materials and manufacturing processes. In particular, the development of new materials and new compounds is a key aspect for the rapid evolution of flow batteries.

A zinc bromide battery generally includes a stack of flow frame assemblies, where a carbon electrode is bonded to each frame. One of the limitations of existing batteries is the inefficient bond between the flow frame and the electrode, which causes failures in battery performance.

Another drawback is that the solids content represents a considerable percentage of the material's formulation. Some solids tend to swell due to the presence of reagents; this tends to produce a differential expansion of the electrode and the frame plastics, thus creating warpage, which highly affects battery performance. By reducing the amount of solids in the formulation, the development of warpage may be decreased arid bonding between the electrode and the flow frame may be improved.

Additionally, flow frames, during battery operation, should be resistant to deformation due to the presence of reagents, such as bromine, or other agents that may cause expansion or degradation. Furthermore, the materials should be suitable for large scale manufacturing and allow specific applications, such as complex geometries, high level of details and thin features; all of which demand optimal formulations with suitable characteristics for proper flow during an over-molding process.

Therefore, there is a need for an improved material formulation of flow battery components to surpass the foregoing limitations and scale up current zinc bromide technology to meet cost and performance requirements on a large scale.

3. Background Art

US20120045680: Dong et al., REDOX FLOW BATTERY (Sep. 10, 2010)

Abstract: A redox flow battery having a high electromotive force and capable of suppressing generation of a precipitation is provided. In a redox flow battery 100, a positive electrode electrolyte and a negative electrode electrolyte are supplied to a battery cell including a positive electrode 104, a negative electrode 105, and a membrane 101 interposed between the electrodes 104 and 105, to charge and discharge the battery. The positive electrode electrolyte contains a manganese ion, or both of a manganese ion and a titanium ion. The negative electrode electrolyte contains at least one type of metal on selected from a titanium ion, a vanadium ion, a chromium ion, a zinc ion, and a tin ion. The redox flow battery 100 can suppress generation of a precipitation of MnO 2, and can be charged and discharged well by containing a titanium ion in the positive electrode electrolyte, or by being operated such that the positive electrode electrolyte has an SOC of not more than 90%. In addition, the redox flow battery 100 can have a high electromotive force equal to or higher than that of a conventional vanadium-based redox flow battery.

U.S. Pat. No. 7,820,321: Home et al., Redox flow battery system for distributed energy storage (Jul. 6, 2009)

Abstract: A large stack redox flow battery system provides a solution to the energy storage challenge of many types of renewable energy systems. Independent reaction cells arranged in a cascade configuration are configured according to state of charge conditions expected in each cell. The large stack redox flow battery system can support multi-megawatt implementations suitable for use with power grid applications. Thermal integration with energy generating systems, such as fuel cell, wind and solar systems, further maximize total energy efficiency. The redox flow battery system can also be scaled down to smaller applications, such as a gravity feed system suitable for small and remote site applications.

U.S. Pat. No. 7,258,947: Kubata et al., Electrolyte for redox flow battery, and redox flow battery (Apr. 30, 2002)

Abstract: The present invention provides electrolyte that can suppress reduction of battery efficiencies and capacities with increased cycles of charge/discharge of the battery, a method for producing the same, and a redox flow battery using the same electrolyte. The redox flow battery use the electrolyte having a NH 4 content of not more than 20 ppm and a relation of Si concentration (ppm)×electrolyte quantity (m³)/electrode area (m²) of less than 5 ppm·m³/m². By limiting a quantity of contaminants in the electrolyte, a clogging of carbon electrodes to cause reduction of the battery performances with increased charge/discharge opera ions can be suppressed.

U.S. Pat. No. 6,524,452: Clark et al., Electrochemical cell (Jun. 22, 2001)

Abstract: A flow-frame for forming a subassembly; said sub-assembly comprising a bipolar electrode and an ion-selective membrane mounted on said flow-frame and wherein said sub-assembly may be stacked together with other such subassemblies to create an array of electrochemical cells; wherein said flow-frame is formed from an electrically insulating material and comprises at least four manifold-defining portions which also define pathways for the passage of the anolyte/catholyte. Such pathway may define a labyrinthine path which may be spiral in shape between the manifold and the chamber entry/exit port.

### SUMMARY

According to various embodiments, the present disclosure includes material formulations for flow frames that may be employed in electrochemical cells incorporated in flow batteries. Formulation process may include steps of dry mixing and extrusion to form pre-formulated pellets. These pre-formulated pellets may later be employed in a plastic injection over-molding process to obtain flow frames, which may beintegrated with electrodes or membranes. Flow frame materials employed in the formulation process may include about 65% wt-90% wt of polypropylene, with a MFI (Melt Flow Index) between 25 and 60 g/10 min at 230° C., 2.16 kg, between 5% wt-15% wt of glass fiber, between 0.5% wt-7.0% wt of a coupling agent and about 3% wt-15% wt of elastomer. For the present disclosure, the final compound may exhibit a MFI of between 12 and 60 g/10 min at 230° C., 2.16 kg, representing a very suitable MFI range for adequate flow during an injection molding process. Polypropylene (PP) may be a single type or a blend of low MFI PP and high MFI PP to achieve the final desired MFI.

Additionally, glass fiber may be employed to reduce flow frame material shrinkage, while coupling agent (e.g. Maleic Anhydride Modified Polypropylene) may be employed for bonding glass to polypropylene, improving flow frame material strength, stability and bromine resistance. Furthermore, a polyolefin elastomer (e.g. ethyleneoctene copolymer) may be employed for enhancing the bonding properties and improving the over-molding process.

The disclosed flow frame formulation may be employed to improve material strength and stability, as well as bromine resistance. Formulation components—bonding additives, polyethylene, PVDF, PVC, among others—for manufacturing the flow frame may be similar to the formulation components for manufacturing of electrodes in order to improve the bonding properties, during over-molding process, between those parts of a cell stack.

Numerous other aspects, features and advantages of the present invention may be made apparent from the following detailed description taken together with the drawing figures.

### LIST OF FIGURES

The present disclosure can be better understood by referring to the following figures. The components in the figures are not necessarily to scale, emphasis instead being placed upon illustrating the principles of the invention. In the figures, reference numerals designate corresponding parts throughout the different views.

FIG. 1 depicts a flowchart of composite preparation, according to an embodiment.

FIG. 2 illustrates composite preparation, according to an embodiment.

FIG. 3 depicts an isometric view of an assembly of flow frames, according to an embodiment.

FIG. 4 illustrates an isometric view of various components of a cell stack of a zinc bromide battery, according to an embodiment.

FIG. 5 shows an isometric view of assembled cell stack of a zinc bromide battery, according to an embodiment.

### DETAILED DESCRIPTION

Disclosed herein is a composition for a flow frame that may be employed in a flowing electrolyte battery, according to an embodiment. The present disclosure is hereby described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### Definitions

As used herein, “battery cell” may refer to an enclosure provided with at least a pair of electrodes and at least one inlet and one outlet configured to allow the flow of electrolyte through the enclosure.

As used herein, “battery cell stack” may refer to one or more battery cells, placed between a pair of terminal electrodes, or end caps, that share a common electrolyte path.

As used herein, “electrolyte” may refer to a substance that allows electricity to flow between a pair of electrodes.

As used herein, “flow battery” or “flowing electrolyte battery” may refer to an electrochemical device that includes at least one battery cell stack and is capable of storing energy.

As used herein, “flow frame” may refer to a battery module component that forms at least a portion of the enclosure of a battery cell, containing at least a portion of paths configured to control the flow of electrolyte through a battery cell stack.

### DESCRIPTION OF THE DRAWINGS

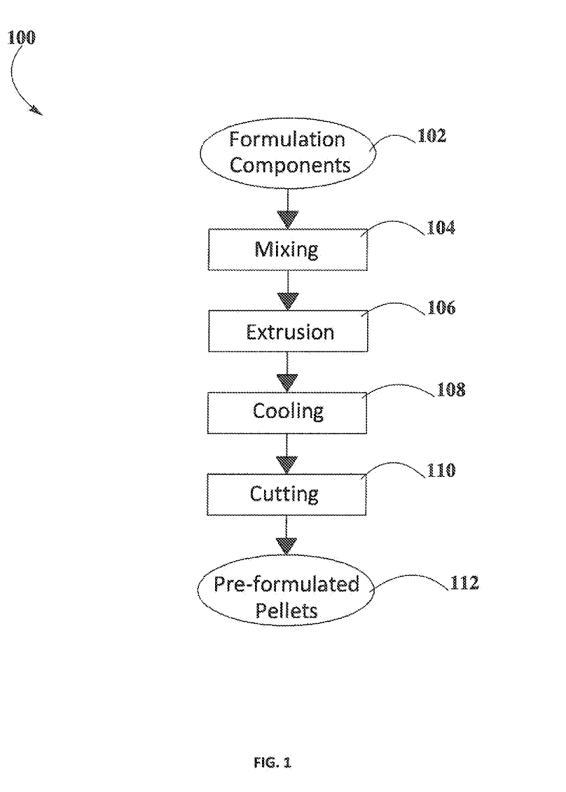

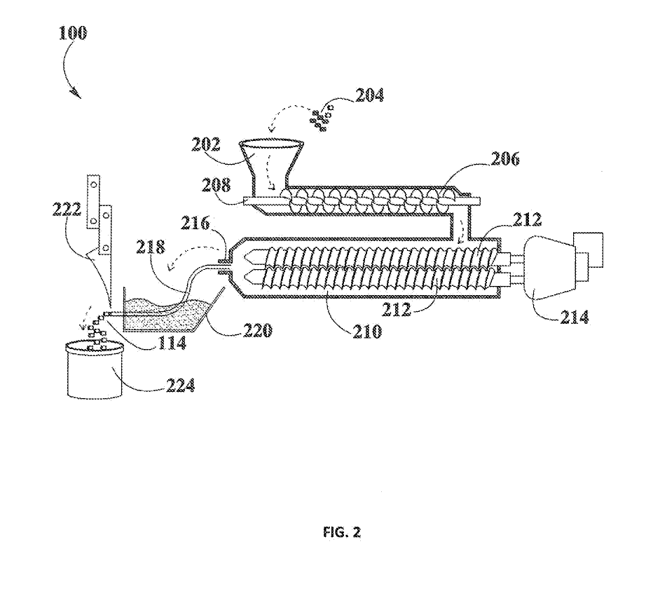

FIG. 1 depicts a flowchart of composite preparation 100. According to an embodiment, composite preparation 100 may include the following steps. First, all formulation components 102 may be mixed together by dry mixing 104 process and subsequently blended in extrusion 106 process to form a blend. The filtered blend may pass over cooling 108 tank to solidify into one or more strands and, subsequently, may be cut employing cutting 110 knife to obtain pre-formulated pellets 112. Pre-formulated Pellets 112 may then be fed into another extrusion process to undergo an over-molding process, where pre-formulated pellets 112 may be employed in the manufacturing of flow frames around electrodes of a flowing electrolyte battery. Composite preparation 100 may be further explained in FIG. 2.

Formulation Components 102 and Properties

In one embodiment, pre-formulated pellets 112 for over-molding a flow frame may include from about 65% wt to about 90% wt of polypropylene (Melt Flow Index—MFI may be between the range of 25 to 60 g/10 min @ 230° C., 2.16 kg), about 5% wt to about 15% wt of glass fiber, between about 0.5% wt and about 7.0% wt of a coupling agent; and from about 3% wt to about 15% wt of elastomer. The polypropylene can be a single type or a blend of low MFI PP and high MFI PP to achieve the final desired MFI. Glass fiber may be employed to reduce the flow frame material's shrinkage, while a coupling agent (e.g. Maleic Anhydride Modified Polypropylene) may be employed to form a suitable interface between the glass and the polypropylene improving the flow frame material's strength and stability, and giving the interface of glass and propylene a better resistance to bromine (i.e. coupling agent does not allow bromine to get into the interface); a polyolefin elastomer (e.g. ethyleneoctene copolymer) may be employed for improving insert molding process.

Suitable formulation components 102 for composite preparation 100 may include materials capable of improving the insert molding bond between electrodes and flow frames. Additives, suitable to increase the mobility and miscibility of the plastics and result in greater cohesion between the insert (i.e. electrode) and flow frame, may include high MFI polypropylene between the range of 60-140 g/10 min at 230° C., 2.16 kg, and polyolefin elastomer (ethyleneoctene copolymer).

The polypropylene used in the formulation components 102 may have a MFI between about 25 and 60 g/10 min at 230° C., 2.16 kg. For the final compound, in pre-formulated pellets 112, MFI (Melt Flow Index) may be between 12 and 60 g/10 min at 230° C., 2.16 kg. Suitable properties of formulation components 102 may include a tensile strength between the range of 5,000 psi-7,000 psi, tensile modulus between 300,000 psi-500,000 psi, tensile strength reduction due to bromine exposure between 0%-10%, tensile modulus reduction due to bromine exposure between 0%-20%, tensile elongation between 3%-10% and a bromine expansion between the ranges of 0%-1.5%.

Suitable suppliers for the PP may be, but not limit to, SIGMA-ALDRICH Corporation, ICC Chemical Corporation, AK Scientific, Inc., and Solvay S.A. Vendors for the glass fiber may include Nanjing Lihua Engineering Plastic Co., Ltd., Pinghu Shanghua Plastic Industry Co., Ltd, among others. Suppliers of coupling agents may include Dow Corning Co., Arkema Canada Inc., among others. Polyolefin elastomer may be purchased at, but not limit to, Dow Chemical Co., DuPont Co., SIGMA-RBI, Chevron Phillips Chemicals, S.A de C.V., Chemical Land21 and R.T. Vanderbilt Company, Inc.

Formulation components 102 for the manufacturing the flow frame may be similar to formulation components 202 for the manufacturing of electrodes, specifically in the quantity of ethyleneoctene copolymer, in order to improve the bonding during the integration of electrodes and flow frame.

Formation of Pre-Formulated Pellets 112

FIG. 2 illustrates a machine process utilized for composite preparation 100. According to an embodiment, the machine process for composite preparation 100, as known in the art, may include of hopper 202, where formulation components 102 may be inserted by direct incorporation in the form of pellets 204 for composite preparation 100. In other embodiments, formulation components 102 may be inserted as powder, sheets, granules, nanotube, among others, in a dimension suitable to be directly incorporated in hopper 202 and to achieve the formulation described in FIG. 1.

Subsequently, pellets 204, inserted into hopper 202, may be mixed by passing through single screw mixer 206 including single screw 208 to achieve an homogeneous mixture of formulation components 102 inserted into hopper 202. Afterwards, mixed pellets 204 may pass through a twin screw extruder 210, where two screws 212 may be co-rotating or counter-rotating, intermeshing or non-intermeshing employing motor 214. In addition, the configuration of screws 212 may vary employing forward conveying elements, reverse conveying elements, kneading blocks, and other designs in order to achieve particular mixing characteristics. Other examples of extruders that may be employed in the present invention are a planetary extruder, single screw extruder, co- or counter rotating multi-screw screw extruder, co-rotating intermeshing extruder or ring extruder.

As mixed pellets 204 pass through extruder 210, pellets 204 may be shear heated, due to the rotation and pressure applied by screws 212, to a temperature above the melting point of mixed pellets 204, forming a blend. The blend may exhibit a MFI not less than a range of about 12 to about 60 g/10 min @ 230° C., 2.16 kg. In order for the blend to exhibit a near-neat polymer melt viscosity (as measured by MFI), the temperature at which the mixing 104 and extrusion 106 process occur may be controlled with a thermometer. In one embodiment, mixing 104 may occur at room temperature and extrusion 106 process may occur at a temperature between the range of about 200° C. to about 260° C. Screws 212 force the blend through die 216, forming the blend into one or more strands 218. As the blend comes out of die 216, strand 218 may be cooled by water, at room temperature, in cooling tank 220 and subsequently, strand 218 may be cut employing motion knife 222 in order to form pre-formulated pellets 112. Cutting 110 may be made by the motion knife 222 in an up and down direction, in order to form pre-formulated pellets 112 of a suitable dimension to be later employed in an injection molding machine for the manufacturing process of flow frames.

Pre-formulated pellets 112 may be exhibit a size between 2 mm and 8 mm, and a diameter of about 4 mm. Finally, pre-formulated pellets 112 may fall down into barrel 224 to be stored and afterwards employed in the manufacturing process of flow frames for flowing electrolyte batteries.

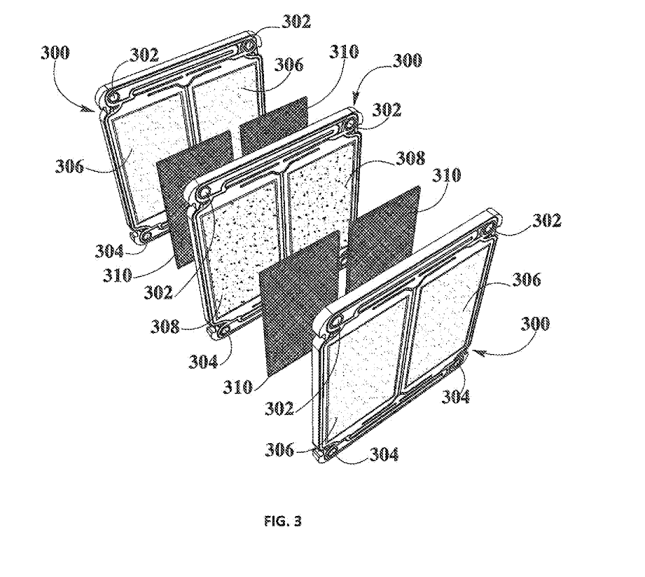

FIG. 3 depicts an isometric view of an assembly flow frames 300. Flow frame 300 may be manufactured employing pre-formulated pellets 112 and may be a component in cell stacks of flowing electrolyte batteries. Flow frame 300 may include upper edge openings 302 and lower edge openings 304. Upper edge openings 302 and lower edge openings 304 may be proximate to each of the corners of flow frame 300, and may provide either an inlet/outlet for electrolyte entering/exiting cell stack or a fluid passage to conduct electrolyte between flow frames 300. Each flow frame 300 may be integrated with electrode 306 or micro-porous membrane 308. For assembly, flow frame 300 with electrode 306 integrated should be followed by flow frame 300 with micro-porous membrane 308 integrated. Between each flow frame 300, half-cell spacer 310 may be placed to separate micro-porous membrane 308 from electrode 306.

According to one embodiment, one of upper edge openings 302 or lower edge openings 304 may provide a fluid inlet, and one of the opposite upper edge openings 302 or lower edge openings 304 may provide a fluid outlet for electrolyte passing over electrode 306 contained in each flow frame 300 and half-cell spacer 310. The other upper edge openings 302 and lower edge openings 304 may define a channel allowing electrolyte to pass through flow frame 300 or half-cell spacer 310. Upper edge openings 302 and lower edge openings 304 may be configured such that electrolyte in the anolyte flow system is directed down to one side of flow frame 300 and electrolyte in the catholyte flow system is directed down to the other side of flow frame 300. Micro-porous membrane 308 isolates the anolyte and the catholyte between adjacent electrodes 306. However, ion transfer may occur across micro-porous membrane 308 allowing current to flow in a cell stack. The electrolyte flowing through a cell stack may be divided into two flow paths to pass over electrodes 306 on alternating sides of flow frames 300.

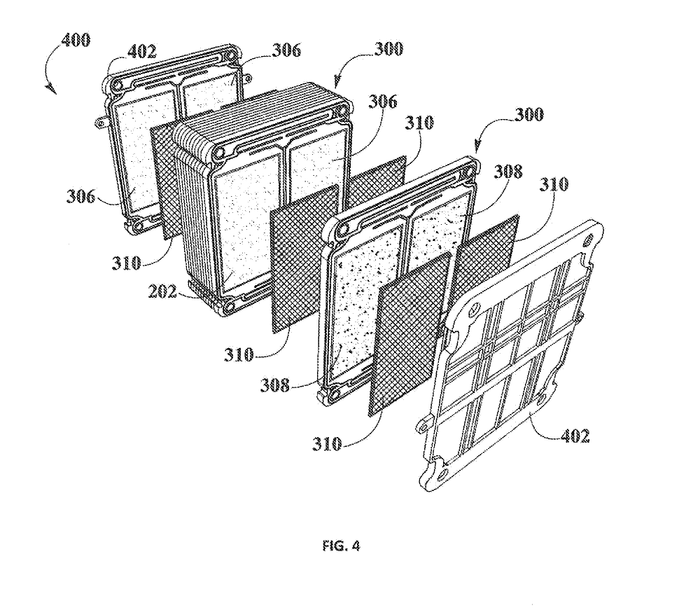

FIG. 4 illustrates various components in cell stack 400 of a zinc bromide flow battery. In some embodiments, cell stack 400 may include a number of flow frames 300, electrodes 306, micro-porous membranes 308, end caps 402, and half-cell spacers 310. Half-cell spacers 310 may be included between each flow frame 300 and may be joined by means of suitable welding methods, e.g, ultrasonic welding and vibration welding, to define flow paths between flow frames 300. Each end cap 402 may be molded in a suitable way that allows including flow paths on the internal side of end cap 402. End cap 402 may be oriented inward to cell stack 400 such that end cap 402 and adjacent flow frame 300 similarly define a flow path. The other side of end cap 402 may be molded in a suitable way that allows including structural features of cell stack 400 and to facilitate the alignment of cell stacks 400 to each other. Each cell stack 400 may be formed by a number of electrodes 306 separated by micro-porous membrane 308.

Flow frame 300 may be employed to hold cell components. The design of flow frame 300 may give consistent flow distribution under a wide range of fluid parameters. Flow frame 300 may be suitable for other flow battery chemistries. Furthermore, flow frame 300 may be applied to achieve 2P distribution through successive bifurcations.

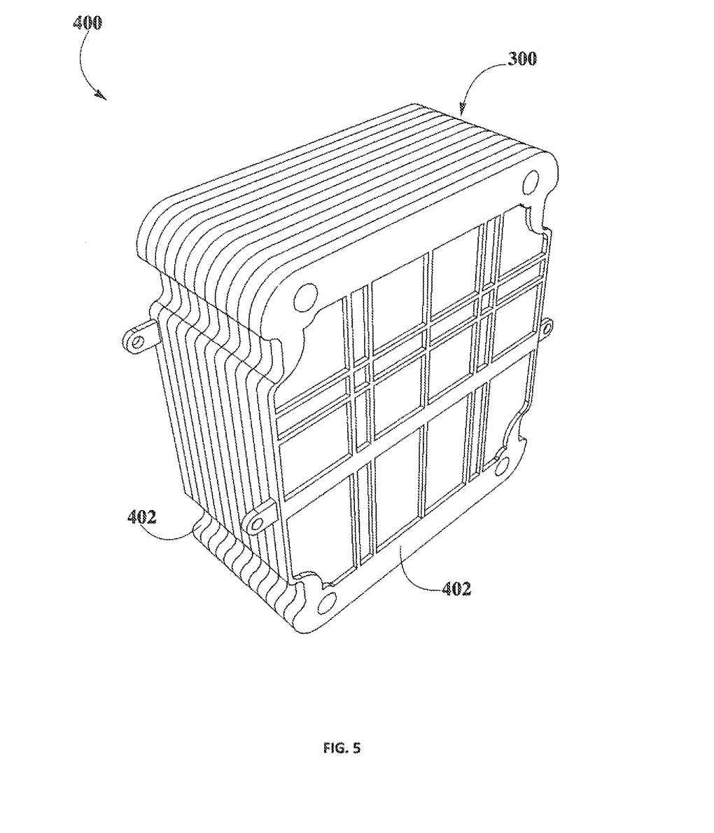

FIG. 5 shows an isometric view of assembled cell stack 400 of a zinc-bromine flow battery. In an embodiment cell stack 400 may be formed of about 60 flow frames 300 disposed between a pair of end caps 402. Each flow frame 300 may be molded to include half flow paths and other features on each side of flow frame 300.

### EXAMPLES

Example #1 is another embodiment of composite preparation 100 in FIG. 1, where specific formulation components 102 may achieve a MFI of about 40 g/10 min at 230° C., 2.16 kg, employing about 70% wt of polypropylene, around 15% wt of glass fiber, about 5% wt of coupling agent and about 10% wt of elastomer, where final MFI of pre-formulated pellets 112 may range between 30 and 60 g/10 min at 230° C., 2.16 kg. Not all materials mentioned before may be required to be present in this formula.

Example #2 is another embodiment of composite preparation 100 in FIG. 1, where alternative formulation components 102 for flow frame 300 materials may include insert molding adhesion promoters, glass beads, talc, mica, coupling agents, stabilizing fillers, crystallinity promoters and anti-oxidants; where the achievable MFI may be around 40 g/10 min at 230° C., 2.16 kg; with a tensile strength of around 6,100 psi; a tensile modulus of about 370,000 psi; a tensile strength reduction due to bromine exposure below 5%; a tensile modulus reduction due to bromine exposure below 10%; a tensile elongation of about 6%; and bromine expansion of about 0.5%.

It should be understood that the present disclosure is not limited in its application to the details of construction and arrangements of the components set forth herein. The present disclosure is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

Thus the scope of the invention should be determined by the appended claims and their legal equivalents, and not by the examples given.

We claim:

1. A composition for use in forming a flow frame for an electrolyte flow battery, the composition comprising:
a. polypropylene;
b. a fibrous material;
c. a coupling agent; and
d. an elastomer.

2. The composition of claim 1 wherein the polypropylene has a melt flow index (MFI) between 25 to 60 g/10 min @ 230° C.

3. The composition of claim 1 wherein the composition comprises:
a. between about 65% wt to about 90% wt of polypropylene;
b. between about 5% wt to about 15% wt of glass fiber;
c. between about 0.5% wt to about 7.0% wt of a coupling agent; and
d. between about 3% wt to about 15% wt of an elastomer.

4. The composition of claim 3 wherein the composition comprises:
a. about 70% wt of polypropylene;
b. about 15% wt of glass fiber;
c. about 5% wt of coupling agent; and
d. about 10% wt of elastomer.

5. The composition of claim 4 wherein the final MFI of the composition is between 30 and 60 g/10 min at 230° C.

6. The composition of claim 1 wherein the polypropylene is polypropylene selected from the group consisting of a single type of polypropylene or a blend of low MFI polypropylene and high MFI polypropylene.

7. The composition of claim 1 further comprising materials capable of improving an insert molding bond between electrodes and flow frames formed with the composition.

8. The composition of claim 7 wherein the materials capable of improving the insert molding bond include include polypropylene with an MFI between the range of 60-140 g/10 min at 230° C., and polyolefin elastomers.

9. The composition of claim 1 further comprising one or more of insert molding adhesion promoters, glass beads, talc, mica, coupling agents, stabilizing fillers, crystallinity promoters and anti-oxidants.

10. The composition of claim 1 wherein the polypropylene MFI is around 40 g/10 min at 230° C.

11. A flow frame for an electrolyte flow battery formed from the composition of claim 1.

12. A cell stack for an electrolyte flow battery comprising about 60 flow frames formed from the composition of claim 1.

13. A method for forming a flow frame for an electrolyte flow battery; the method comprising the steps of:
a. placing the components in a compounder to mix the components into the composition;
b. extruding the composition;
c. cooling the extruded composition;
d. cutting the cooled composition into pre-formed pellets; and
e. molding the pre-formed pellets into the flow frame.

14. The method of claim 13 wherein the step of molding the pellets into the flow frame comprises injection molding the pellets to form the flow frame.

15. The method of claim 13 wherein the pre-formed pellets have a length between 2 mm and 8 mm, and a diameter of about 4 mm.

16. The method of claim 13 wherein the step of extruding the composition occurs at a temperature between the range of about 200° C. to about 260° C.
